(19) United States
(12) Patent Application Publication
(10) Pub. No.: US 2014/0032435 A1
(43) Pub. Date: Jan. 30, 2014

(54) METHOD AND APPARATUS FOR ENHANCING JOB RECRUITING

(71) Applicant: Sheeroy DESAI, San Francisco, CA (US)

(72) Inventor: Sheeroy DESAI, San Francisco, CA (US)

(73) Assignee: GILD, INC., San Francisco, CA (US)

(21) Appl. No.: 13/557,812

(22) Filed: Jul. 25, 2012

(51) Int. Cl. G06Q 10/06

(52) U.S. Cl. 705/321

(57) ABSTRACT

A recruitment enhancement system is disclosed that can be used by job recruiters to assess job applicant's suitability for particular jobs. The recruitment enhancement system includes a module for generating and encouraging individuals to participate in recruitment enhancement activities, such as knowledge-based contests. An individual may be able to participate in the activities via their mobile device. One purpose of the activities can be to increase awareness about a particular company. Thus, the activities can be branded. In one embodiment, information derived from the activities can be used to assess the participant's suitability for various job positions.

### FIELD OF THE INVENTION

The present invention is generally related to employment recruitment tools. More particularly, the present invention is directed to providing recruitment activities, such as knowledge-based contests, that can be used to attract and identify promising job recruits.

### BACKGROUND OF THE INVENTION

An applicant tracking system is a software application that enables the electronic handling of recruitment needs. Nearly all major corporations use some form of applicant tracking system to handle job applications and to manage resume data. The principal function of an applicant tracking system is to provide a central location and database for a company's recruitment efforts. Applicant tracking systems are built to better assist management of resumes and applicant information. Data can either be collected from internal applications via the applicant tracking system's front-end, located on the company website or can be extracted from applicants on job boards.

Not long ago, job applicants often learned of available jobs advertised in printed media, such as newspapers or job posting boards where written descriptions of jobs printed on paper were posted to the board. To apply for an available job, the job applicant typically submitted a resume on paper. For instance, to seek a job position available at a company, the job applicant would mail their resume to an address associated with a human resources department listed in the advertisement. After receiving the resume, a portion of the information from the resume was entered, often manually, into an applicant tracking system.

Today, the tasks described above are more and more being performed electronically. Jobs are advertised electronically and applicants submit their resumes electronically. The submission of the resume electronically allows for a larger set of information to be automatically transferred to the applicant tracking system as compared to the process of manual entry from a paper resume. Some advantages of performing these recruiting tasks electronically are the ability to reach a greater pool of applicants and the ability to obtain greater amounts of searchable data about the applicants.

In recruiting, at some point a manual filtering process takes place. In the manual filtering process, recruiters select particular applicants for greater scrutiny, such as an interview. A disadvantage of performing the recruiting tasks electronically is that so much data can be received from so many different applicants that the task of filtering the applicant data to determine which applicants to recruit becomes difficult and time consuming. For example, hundreds or even thousands of resumes can be received for a single job opening. As a result of the difficulties associated with filtering large amounts of applicant data received electronically, many opportunities for recruiting potentially valuable employees are lost because their information can't be separated from the vast pool of applicant data that is received. Thus, the value of electronic recruiting, such as enabled by applicant tracking systems, is greatly reduced. In view of the above, new methods and apparatus for electronic recruiting are desired.

### SUMMARY OF THE INVENTION

A recruitment enhancement system is disclosed that can be used by job recruiters to assess job applicant's suitability for particular jobs. The recruitment enhancement system includes a module for generating and encouraging job applicants to participate in recruitment enhancement activities, such as knowledge-based contests. The participant's performance in the recruitment enhancement activities can be evaluated and characterized. Job recruiters can use the characterization of the participant's performance in the recruitment enhancement activities to identify candidates for a job position or filter applicants that have applied for a job position.

One aspect of the described embodiments relates to a method of electronic job recruiting in a server including a processor and memory. The method can be generally characterized as comprising: a) determining in the processor a recruitment enhancement activity useful for filtering job candidates in a recruiting process is to be generated; b) generating in the processor an interface state that allows a participant to grant access to social media information from a social media site; c) retrieving in the processor the social media information from the social media site; d) generating in the processor a plurality of interface states that allow the participant to participate in the recruitment enhancement activity; e) scoring in the processor the participant's participation in the recruitment enhancement activity; f) based upon the participant's score, ranking in the processor the participant's performance; and g) generating in the processor an interface state that allows a job recruiter to view the participant's score, ranking and the social media information retrieved about the participant from the social media site.

### BRIEF DESCRIPTION OF THE DRAWINGS

FIG. 1 is a block diagram of a recruitment ecosystem in accordance with an embodiment of the present invention.

FIG. 2 is a flow chart of a method of job recruiting in accordance with an embodiment of the present invention.

FIGS. 3-5 are pages of an administrative interface for configuring a recruitment activity in accordance with an embodiment of the present invention.

FIGS. 6-13 depicts a number of different interface states involving a user participating in a recruitment activity implemented on a portable electronic device in accordance with embodiments of the present invention.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

As will be described in more detail as follows, a recruitment enhancement system for electronic job recruiting system is described. The recruitment enhancement system is configured to gather and analyze information about job applicants or prospective candidates for jobs. One objective is to engage individuals to promote knowledge and interest in a company. The engaged individuals may eventually become prospective job candidates. Another objective of the analysis is to identify job applicants most suitable for available job positions. For example, a job applicant's proficiency or knowledge pertaining to a particular aspect of a job can be assessed and scored, such as their knowledge or proficiency of a particular programming language for a programming job. The scoring can be used to rank applicants.

The information derived from the analyses, such as the scores, can be referred to as job suitability parameters. The job suitability parameters can be designed to aid job recruiters during the manual filtering process of job applicants. The recruitment enhancement system can be configured to generate an interface that allows job recruiters to access the job suitability parameters for various candidates.

The recruitment enhancement system can be configured to gather information used to derive job suitability parameters directly or indirectly. Direct information gathering can involve configuring an activity and then getting an individual, such as a job applicant or a potential job applicant to engage in the activity. During the engagement process, the individual may learn about and become aware of a company as a result of their participation in the activity. Further, the individual may provide information that allows the company to learn more about the individual. Based upon the learned information, a decision can be made as to whether to attempt to further engage the individual.

A general trivia contest that is sponsored by a company is an example of a direct information gathering activity. The contest can be branded with information about the company, such as a company name and logo, so that the participant becomes aware of the company. Before beginning the contest, the participant can be required to provide identification information, such as logging in with their Facebook™ or Linkedin™ account. Thus, the contest sponsor may be able to gather additional information about the participant.

Some direct information gathering activities may allow the skills of an applicant to be assessed. When the individual, such as a job applicant, engages in the activity, information from the user's participation can be gathered and analyzed. For example, the job applicant can be asked to engage in a knowledge based contest related to a skill associated with a job. The job applicant's answers can be scored or evaluated in some manner to provide some indication of the applicant's skill level. At the very least, as described above with respect to the general trivia contest, the activity may have increased awareness about the sponsor and the sponsor may have gained information about individuals that are potentially interested in them.

Indirect information gathering can involve harvesting information from a job applicant's online activities. One source of information that can be gathered an analyzed may be from an applicant's participation in social media activities. Another source of information that can be gathered and analyzed may be from an applicant's participation in professional related activities. Many potential information sources are available and these examples are provided for the purposes of illustration only and are not meant to be limiting.

As an example of an information source associated with professional related activities that can be used to generate a job suitability parameter, computer programmers often post publically available code related to personal projects. Their projects can be followed by other programmers. Via the recruitment enhancement system, the code can be gathered and analyzed as a component of a recruitment enhancement system to assess the programmer's abilities and suitability for various programming jobs. From the analyses, job suitability parameters can be derived that are made available to job recruiters.

The description to follow is primarily focused on direct information gathering and its analysis as part of a recruitment enhancement system. For example, methods and apparatus for providing knowledge based contests involving direct participation of job applicants are described. Information derived from the contests can be used to assess a job applicant's suitability for a particular job. Methods and apparatus associated with indirect information gathering that can be used in a recruitment enhancement system are described in more detail with respect to co-pending U.S. application Ser. No. 13/499,791, entitled “Recruiting Service Graphical User Interface,” by Bonmassar, et al., filed Jun. 11, 2012, which is incorporated herein in its entirety and for all purposes.

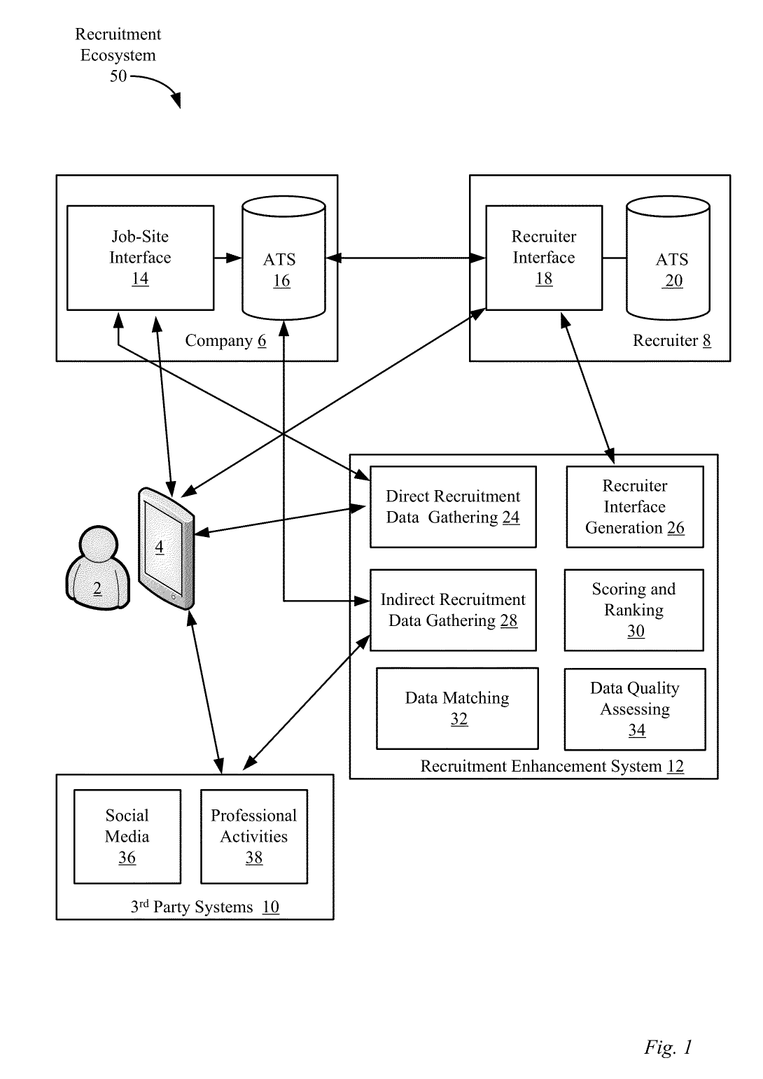

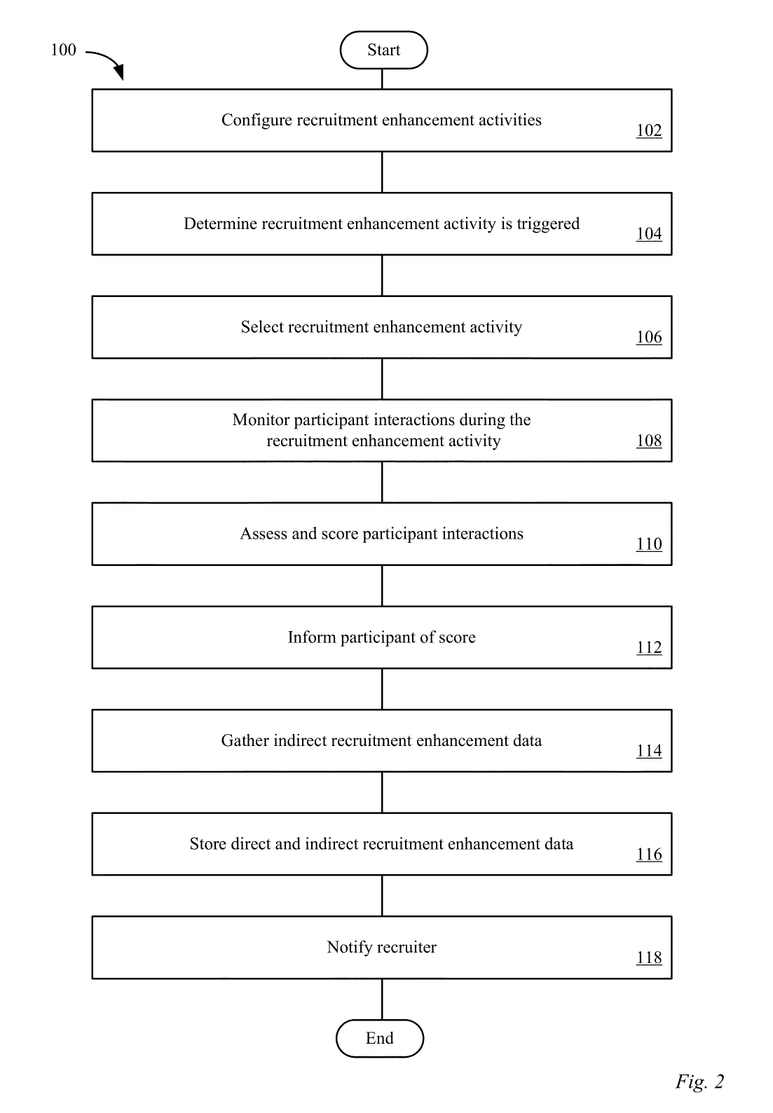

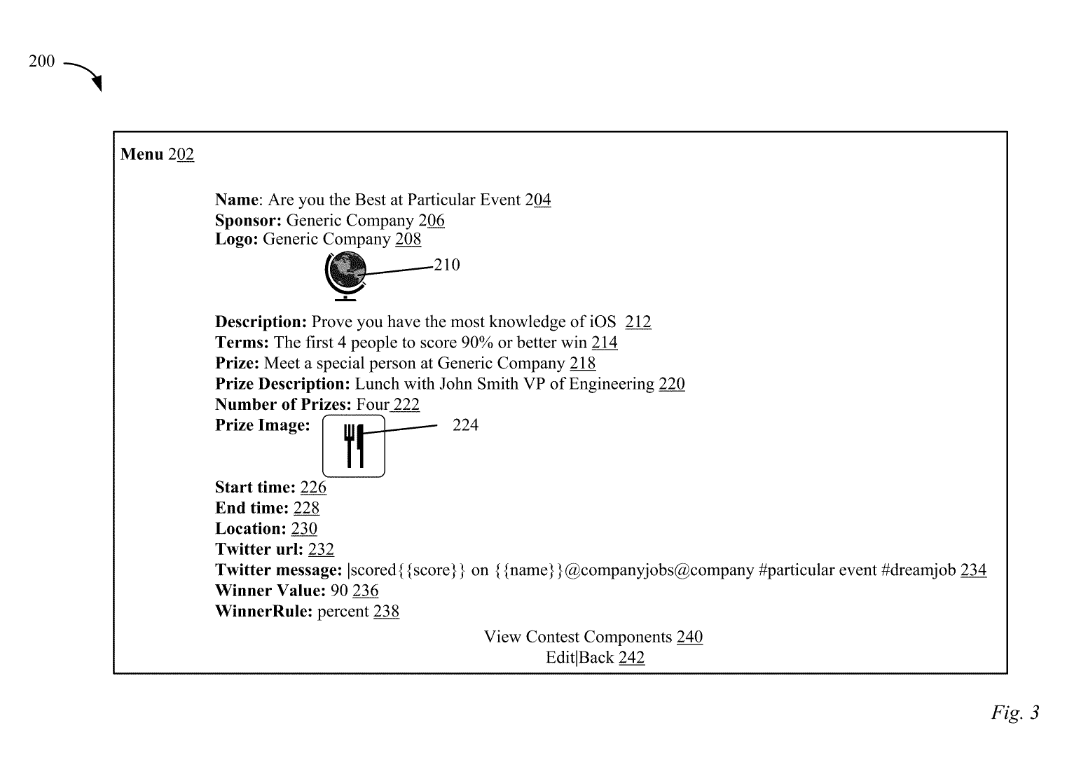

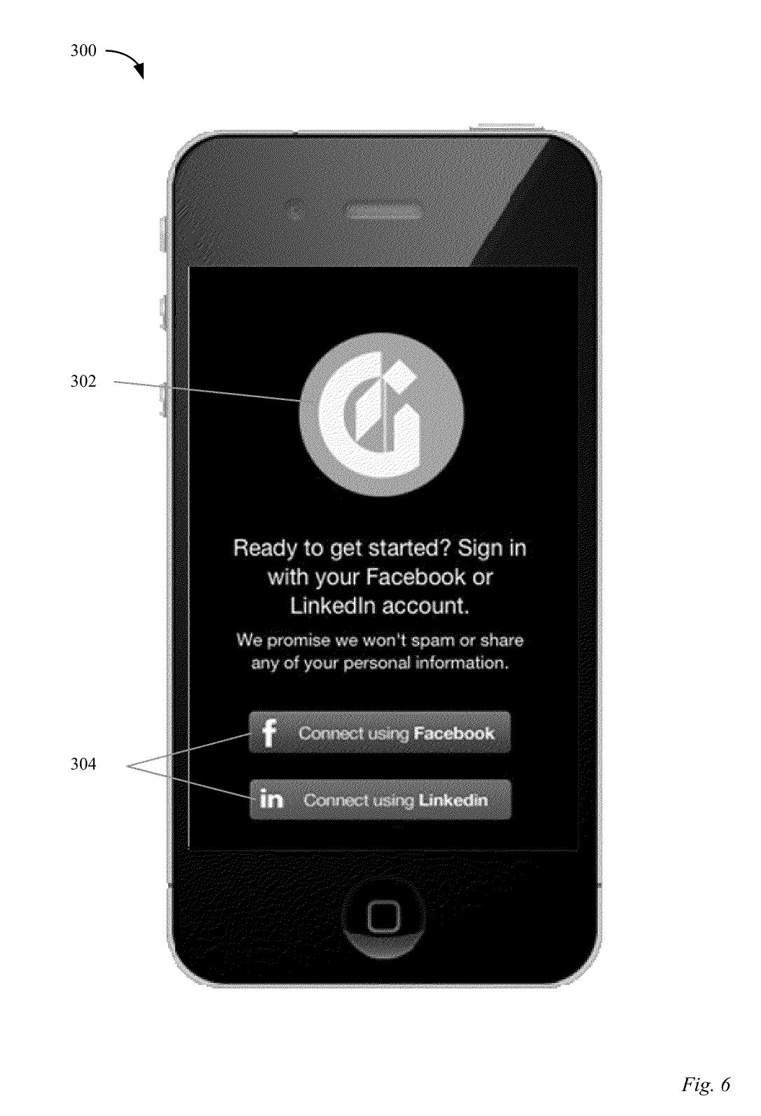

In particular, a block diagram of a recruitment ecosystem including a recruitment enhancement system is described with respect to FIG. 1. Various scenarios in which information is directly gathered by the recruitment enhancement system for the purposes of generating job suitability parameters are discussed. With respect to FIG. 2, a method of job recruiting using a recruitment enhancement system configured to generate activities used to gather information about potential job applicants is described. With respect to FIGS. 3-5, a number of pages of an administrative interface for configuring a knowledge-based recruitment activity used in the recruitment enhancement system are discussed. Finally, with respect to FIGS. 6-13, a number of different interface states involving a user participating in a recruitment enhancement activity implemented on a portable electronic are described.

### Recruiting Ecosystem

In this section a recruiting ecosystem including a recruitment enhancement system is a described. In a recruiting ecosystem, individuals can engage with various electronic systems to supply information that allows them to apply for existing jobs or to be considered for future jobs when positions open up. In response to the supplied information, recruiters can select from among the individuals and attempt to initiate additional job recruiting related interactions. For instance, based upon the received data, a job recruiter can identify an individual and attempt to contact the person for additional interactions, such as to set up an interview.

A job candidate can be a person that is interested in working for company and has agreed to provide information. A job applicant can be a person that has applied for a job and agreed to provide information as part of the application process. As described herein, a recruitment enhancement system 12 can be provided that can be used to gather information and engage job candidates and job applicants alike. In addition, the recruitment enhancement system 12 can be configured to gather information about individuals that have engaged with a company in some manner. For example, the individual may have learned about the company through participation in a direct information gathering activity sponsored by the company, such as a contest of some type.

In the recruitment enhancement system, methods and apparatus can be provided for gathering secondary recruitment data that is beyond the resume and other application data that is usually gathered in the job application process. The secondary recruitment data can be analyzed and scored.

Based upon the score, one or more rankings for a job candidate can be generated. For example, an individual in the recruitment enhancement system 12 can be ranked independent of or relative to a group of other job candidates or job applicants, such as a group of job applicants applying for the same job or a group of job candidates within the same profession. An independent rank can involve comparing the individual's performance to some derived scale. A relative rank can involve comparing the individual's performance to other individuals within a group.

The recruitment enhancement system 12 can be configured to generate an interface that allows an outside entity such as a job recruiter to access the ranking data. The outside entity can use the ranking data as a basis for additional investigations, such as learning more about particular individuals, and determining whether to contact particular individuals for additional interactions, such as a job interview.

In particular embodiments, the recruitment enhancement system 12 can be tailored to particular professions. For example, the recruitment enhancement system 12 can be tailored towards the computer programming profession where the system is configured to gather secondary recruitment data that allows computer programming professionals to be ranked according to some scale and/or relative to other computer programming professionals that have participated in a common recruitment enhancement activity. In another example, the recruitment enhancement system 12 can be tailored towards medical professionals, such as doctors or nurses, where the system is configured to gather secondary recruitment data that allows the doctors or nurses to be ranked.

FIG. 1 is a block diagram of a recruitment ecosystem 50 including a recruitment enhancement system 12 in accordance with the described embodiments. The ecosystem 50 includes company systems, such as 6, recruiter systems, such as 8, a recruitment enhancement system, such as 12 and 3^{rd} party systems where individuals can engage in various activities, such as 10. Social media sites are one example of 3^{rd} party systems. An individual 2, who may or may not be currently engaged in the job hunting process may interact at various times with each of the systems via a computational device, such as the tablet device 4. Typically, the interactions may involve establishing communications between the computational device and one or more remote servers associated with each of the systems over a local and/or wide area network. For instance, the tablet device 4 can be used to establish communications and interact with a server associated with a social media site.

Communication devices typically include a processor, a memory, networking capabilities and a user interface that allows for the input and output of data. Examples of communication devices that can be utilized include but are not limited to smartphones, latptop computers, netbook computers, desktop computers and tablet computers. Interface devices that can be utilized include a display, a keyboard, a microphone in combination with speech recognition, a mouse, a touchpad and a touchscreen.

The recruitment enhancement system 12 can include components for a) direct gathering of recruitment data 24, b) generating a recruiter interface 26, c) indirect gathering of recruitment data 28, d) scoring and ranking 30, e) data matching 32 and f) data quality assessing. The system 12 can be hosted on one or more servers including processors, memory and network interfaces. Direct recruitment data gathering 24 can involve generating one or more activities in which an individual can directly participate, such as a knowledge-based test, a game, a puzzle or solving a problem.

In general, the capturing of data from an individual engaging in an activity can be part of direct recruitment data gathering. For instance, an individual engaging in an activity, such as an interview, can be captured on video data as part of direct recruitment data gathering 24. In another example, when an individual takes a test, information such as their answers, how long they take to answer each question and their total time can be gathered and analyzed.

The indirect recruitment data gathering can involve gathering information from an individual's on-line activities, such as participation in social media sites 36, professional sites 38 or even sites related to a user's hobbies. The person's on-line activities can be hosted on 3^{rd} party systems 10, such as a social media site. In one embodiment, as is described in more detail below with respect to FIGS. 6-13, when a user agrees to participate in an activity involving direct recruitment data gathering, a user may agree to provide access to their on-line activity information which can be captured by component 28. For example, a user can provide access to their Facebook™ or Linkedin™ profile for a chance to participate in a knowledge-based test related to recruiting. The knowledge-based test can be referred to a recruitment enhancement activity. After access is granted, the indirect recruitment data gathering component 28 can retrieve information about their on-line activities from the 3^{rd} party systems.

The information gathered by components 24 and 28 can be stored and analyzed. Then, job suitability parameters can be derived. For example, the scoring and ranking components 30 can be used to score information directly gathered during an online test and then rank individuals based upon the scores. In addition, information about an individual's online activities can be gathered indirectly from various third-party systems 10 and job suitability parameters can be derived from this information. For example, based upon executable code that a user has posted to a professional site, the individual's coding ability can be scored and ranked.

In particular embodiments, scores and ranks can be derived from data that is gathered directly and/or indirectly. For example, as will be described below, a score and/or a rank can be generated based upon an individual's participation in a knowledge-based test. In another example, a score and a rank can be generated based upon an individual's participation in a knowledge based test and information retrieved from a third-party site, such as social media site. Again, a person can be ranked relative to a group of other individuals, such as a group of individuals participating in a common task, or according to some derived scale or measure.

The data matching component 32 can be used to match various data sets to a particular individual. For example, an individual may use multiple names in their on-line activities. As another example, different individuals can share a common name. The data matching component 32 may use information verified from one source to validate another information source. For example, if an individual grants access to their Facebook™ profile and then another source of information is available, such as their profile in a professional organization or data that they have supplied in applying for a job, the information from the two sources can be compared by component 32 to see if they are the same person. When the comparison indicates they are the same person, a portion of the information from the multiple sources can be stored at the system 12 or at least the links to the multiple sources can be stored. This information can be made available in a recruiter interface.

The data quality assessing component 34 can be used to assess a validity of gathered data. For example, the component 34 might be used to determine whether someone has cheated on a knowledge-based test administered by system 1. As another example, the component 34 might be used to determine whether a person has falsified data they have provided as part of a job application. Information that is identified as invalid may be flagged. In addition, the system 12 can be configured not to use information identified as possibly invalid for scoring and ranking purposes.

The recruiter interface 26 can allow recruiters to access some portion of the information available at system 12. For example, via the interface, recruiters may be able to access scores and ranks about various individuals. Further, via the interface a recruiter may be able to search for individuals with particular skills and assess their job suitability parameters, such as scores and ranking.

The company 6 and the recruiter 8 can each maintain applicant tracking systems, such as 16 and 20. If a recruiter 8 works for the company 6, then the recruiter 8 may not maintain a separate applicant tracking system. The recruiter 8 may have access to an interface or interfaces that allows them to interact with the recruitment enhancement system 12, an individual 2 via their device 4 or some other mechanism, their own application tracking system 20 and a company application tracking system 16.

The company 6 can sponsor a job-site interface 16. Via the job site interface 14, an individual, such as 2, may be able to learn about different jobs and optional apply for jobs. Information from the job application process can be stored to the company application tracking system 16. In particular embodiments, the company 6 may allow recruiters, such as 8, and/or the recruitment enhancement system to access the application tracking system 16.

In one embodiment, one or more direct recruitment data gathering activities can be triggered from the job-site interface 14. For example, when a user applies for a particular job, such as after submitting their information or a part of submitting their information, a link can be established from the job-site interface 14 to the recruitment enhancement system 12. The recruitment enhance system 12 can then generate a recruitment enhancement activity that is used to directly gathered recruitment data. For example, as part of the recruitment enhancement activity an individual may be asked to take a knowledge-based test, play a game, solve a puzzle, solve a problem or combinations thereof.

Information captured from the recruitment enhancement activity can be scored or ranked and made available to recruiters via the interface generated by the recruiter interface generation component 26. An individual can participate in a number of different recruitment activities. Thus, the interface may allow a recruiter to view descriptions of the recruitment enhancement activities in which an individual has participated and jobs suitability parameters derived from their performance.

In one embodiment, via the interface, a recruiter may be able to send a request to an individual to participate in a particular job enhancement activity. For instance, the recruiter may be interested in an individual for a particular job position. Via the interface, the recruiter can send a message to the individual indicating their interest in the person and requesting them to participate in a recruitment enhancement activity, such as taking a knowledge-based test associated with the job position. The message received by the individual can include information, such as a link to a web-site, which allows the individual to engage in the recruitment enhancement activity.

In one embodiment, the recruitment activity that is selected can be related to information associated with an available job. For example, a knowledge-based test can be implemented that is related to a skill needed for the job position. Their answers can be scored and the person can be ranked relative to other job applicants that have taken the test.

In other embodiment, the recruitment enhancement activity that is selected can be related to information supplied by the individual applying for the job. Via interface 14, an individual can submit information indicating that they possess a particular skill at a particular skill level, such as a number of years of experience in the skill. For instance, the interface can ask the person to indicate how many years of experience the person has with the skill or the person can submit a resume including this information.

Based upon information supplied by the individual, the system 12 can be configured to select a recruitment enhancement activity that in some way measures or is predictive of the person having the claimed skill. For example, an individual can be asked to take a knowledge-based test associated with their claimed skill. Harder or easier test can be implemented depending upon the person's claimed skill level. The test answers can be received by the system 12, scored and analyzed. The scores and analyses can be used to assess individuals in regards to their proficiency in the claimed skill. In addition, the individual can be ranked relative to other individuals with the same claimed skill level or according to a scale constructed for individuals of the claimed skill level.

The system 12 can also be configured to implement recruitment enhancement activities in scenarios other than applying for a job. For example, contests involving recruitment enhancement activities, such as knowledge based tests can be implemented as part of a job faire. Individuals can be enticed to participate in the contest via some method, such as for a prize. Information about the individual's participation in the activity associated with the contest can be captured and evaluated by system 12. Based upon the evaluation, individuals can be scored or ranked. Prizes can be awarded based upon their achieved score or rank.

The system 12 can be configured to make information about an individual's score or rank in the recruitment enhancement activity available to recruiters. For instance, the information can be made available via an interface generated by the system. Recruiters, such as 8, may subsequently use this information to determine whether to contact the individual, such as in regards to their interest in an internship or a job at the company. Additional details of scenarios involving the recruitment enhancement system are described below with respect to FIGS. 3-13.

### Method of Job Recruiting in a Recruitment Enhancement System

With respect to FIG. 2, a method 100 of job recruiting in a recruitment enhancement system is described. In 102, a recruitment enhancement activity can be configured. The recruitment enhancement activity can be configured to generate one or more job suitability parameters that allow the suitability of different individuals for a particular job to be assessed. For example, the recruitment enhancement activity can be scored and individuals that have participated can be ranked relative to one another.

The scoring and ranking information can serve as job suitability parameters that allow a recruiter to filter potential to be recruited candidates for a job. One example of recruitment enhancement activity can be a knowledge-based test. An example of administration interface for configuring a knowledge-based test is described as follows with respect to FIGS. 3-5.

In one embodiment, as part of a configuration process, a user may have to download an application. For instance, a user can download an application from an app store to their smart phone. In other embodiments, the user may simply navigate to a web-site to participate in a recruitment enhancement activity. The web-site can be configured for generating output on a mobile device, such as via a browser application executing on the mobile device.

In 104, a determination can be made that recruitment enhancement activity has been triggered. For example, an individual may simply make a request to engage in the activity, such as to take a knowledge-based test. In another example, as described above, an individual can apply for job, such as at a company web-site. At some point during the application process, a recruitment activity can be triggered, such as in response to the user submitting particular information. In yet another example, a recruitment enhancement activity can be triggered via some interaction performed with an electronic device. For instance, a user can scan a QR code or place their device near a wireless interface, such as a near field communication interface to trigger the activity.

In 106, a recruitment enhancement activity can be selected for the user. For instance, if an individual is applying for a job, a recruitment enhancement activity can be selected that is related to the job where different jobs may utilize different enhancement activities. For example, a first knowledge-based test can be implemented in response to an application for a first job and a second knowledge-based test can be implemented in response to an application for a second job. In other embodiments, a user may select a particular recruitment enhancement activity in which they wish to engage.

In yet another embodiment, a recruitment enhancement activity can be selected for an individual based upon information the individual has provided. For example, an individual can provide information about particular skills. The recruitment enhancement system can be configured to select or generate a recruitment enhancement activity that can be used to measure whether the person actually possess the skill they claim. For instance, if an individual claims to have a particular programming skill a knowledge-based test related to a particular programming language can be selected.

In 108, the recruitment enhancement activity can be instantiated and the system can monitor user interactions during the activity. In 110, the participant interactions can be scored and assessed. The scores can be used to rank participants in some manner. In some instances, the participant can be notified of their score and a rank, such as a rank relative to other participants. For example, as described below with respect to FIGS. 6-13, in 112, a leader board can be generated. In other instances, the participant may not be told how well they performed individually or how well they performed relative to other participants. However, this information can be generated and made available to other entities, such as job recruiters.

The system can keep track of whether an individual has already participated in activity. In some instances, depending on the activity the user may only be allowed to participate in a recruitment enhancement once. For example, an individual may only be allowed to take a knowledge-based test once. In other examples, an individual may be allowed to partake in a particular recruitment enhancement activity multiple times and potentially improve their score or rank.

In 114, the system can gather indirect recruitment enhancement data. For instance, to participate in the recruitment enhancement activity, a user may have been required to grant access to some information at a social media site, such as a profile at Linkedin™, which can be gathered. In 116, recruitment enhancement data gathered directly or indirectly can be stored. Optionally, links to some of the data can be stored. For example, rather than storing an entire profile at a social media site. A link to the profile can be stored.

In 118, based upon a participants score, a recruiter can be notified. For example, if an individual does well at recruitment enhancement activity at a conference. A recruiter, also at the conference, can be notified immediately so that they may potentially meet with the individual. In another example, a recruiter can receive a list of individuals that have participated in a recruitment enhancement activity involving a contest. The recruiter can receive a list of individuals that did well in a contest that was held over a particular time period. An example of such a contest is described as follows with respect to FIGS. 3-13.

### Interface for Configuring Recruitment Enhancement Activity

In this section, an interface for configuring a recruitment enhancement activity that can be used in a recruitment enhancement system is described. The interface can be used to configure a knowledge based contest. Job applicants or potential job applicants can participate in the knowledge based contest. Other types of recruitment enhancement activities are possible and the example of a knowledge based contest is provided for the purposes of illustration only and is not meant to be limiting. For example, as part of a recruitment activity used to gather information, a participant can be requested to engage in a game, solve a puzzle or perform a specified task, such as program a solution to a problem.

Information gathered directly from the knowledge-based contest can be used to derive job suitability parameters, such as score or ranking. Further, when participants agree to participate in the recruitment activity, the participant may grant to access to their personal information, such as information stored at a social media account (e.g., Facebook™, Linkedin™ or Google+™). Information gathered from the social media account can trigger searches for information from other sources. The job suitability parameters and other information gathered directly or indirectly about participants in the knowledge-based contest can be made available to job recruiters via an interface generated from the recruitment enhancement system.

FIGS. 3-5 are examples of pages, 200, 250 and 270 that can be provided as part of an administrative interface for configuring a recruitment activity including a knowledge-based contest. An example of an implementation of a configured recruitment on a portable electronic device is described with respect to FIGS. 6-13. In FIG. 3, interface page 200 includes a selectable menu button 202. The selectable menu button may allow an admin to access other pages of the interface, such as 250 and 270. The view contest components 240 and edit/back buttons 242a can also be selected to access different pages of the admin interface.

Via the interface, an admin can specify a contest name 204. For instance, the admin can enter the name 204, “Are you the best at a particular event?” The event might be a conference or exposition where the contest is to be implemented. The contest can be sponsored by a particular entity, such as an entity hosting the conference or a company participating in the contest. In one embodiment, the interface can be configured to receive a specification of the sponsor, such as a name 208.

If a sponsor is specified, the interface can be configured to allow an image associated with the sponsor to be uploaded. For example, an image of a company logo, such as 210, can be uploaded. The uploaded image can be used as part of a description of the contest and/or advertising indicating the existence of the contest.

The interface can be configured to receive a brief description of the contest. The description may be limited to a maximum number of characters. For example, in 212, the brief description is “Prove you have the most knowledge at iOS.” The brief description 212 can be used in advertising for the contest.

The terms 214 can define a criterion for winning the contest. The interface can be configured to receive a selection of a contest criterion. For example, in 214, the criterion is the first four people to score 90% or better win. As another example, the four highest scoring individuals can win. In one embodiment, when the criterion is met, the contest can end and additional participants may no longer be allowed to participate in the contest.

In another embodiment, even after the winners have been determined, individuals may still be allowed to participate in the contest. The contest may be scored and a leader board can be posted. Thus, participants may wish to see how they scored relative to other participants even if they are no longer eligible for a prize.

The interface can be configured to receive a specification of a prize 214. Prizes can be items, such as a cash, goods or services, such as goods or services associated with the sponsor of the contest. In addition, prizes can be an experience, such as a chance to meet a particular person at a company or a chance to visit and receive a tour of a company. In 220, the prize is a chance to win a lunch with John Smith who is the VP of engineering at the company.

In particular embodiments, the prize can be a recruiting related prize. For instance, as described above, an opportunity to visit or meet someone at a company that is recruiting. In another example, the prize can be a chance to meet with a recruiter at the company or even receive an interview at the company.

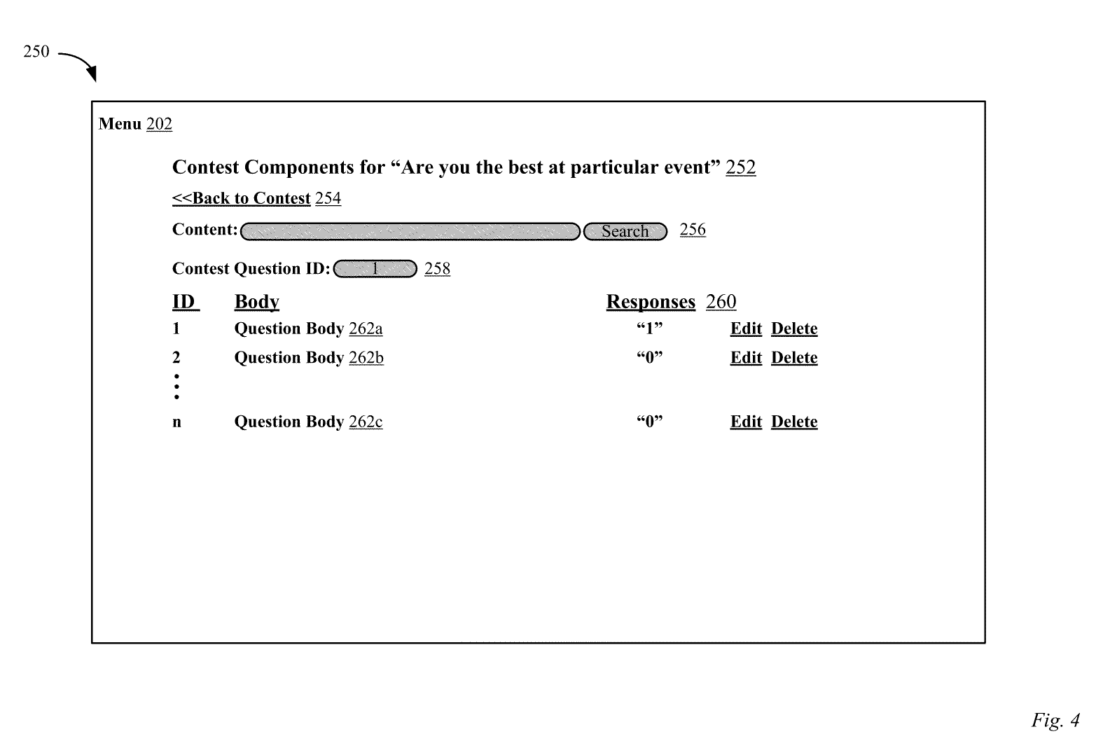

The interface can be configured to receive a number of prizes that are to be awarded. In FIG. 4, the number of prizes 222 is four which corresponds to the number of people that can have lunch with the special person at the company. The interface can be configured to allow an admin to upload prize associated content. For instance, the prize associated content can be an image, a video and/or audio data associated with the prize. For example, the prize associated content 224 is an image selected to indicate the prize is associated with dining. As another example, the prize associated content could be a video and/or audio snippet of describing information about the person (e.g., John Smith) at the company who is going to attend the lunch.

In particular embodiments, contests can be time limited. For example, a contest may be made available during a particular event that has a beginning and an end, such as 3 days. Thus, the interface can be configured to receive an input of a start time 226 and an end time 228 for the contest.

In one embodiment, the contest can be location limited. For instance, the contest may only be available to individuals within a radius of a certain location, such as around a particular convention center. A server remotely hosting the contest or an application executing on a user's device generating the contest may attempt to verify an individual's location before allowing the individual to participate in the contest. For example, a GPS sensor on a user's smart phone can be used to determine a location that is verified by a contest application executing on their device. The location information can also be sent to a remote server that is hosting the contest which can verify location eligibility. In one embodiment, the location 230 can be entered GPS coordinates, such as a longitude and latitude.

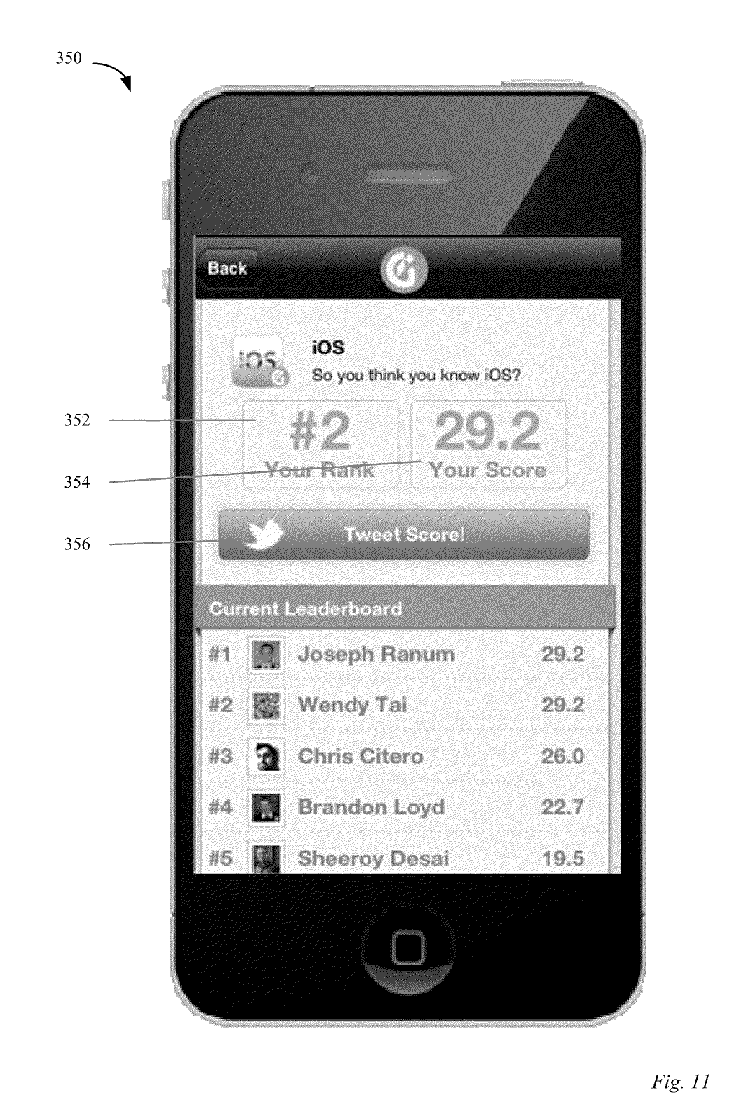

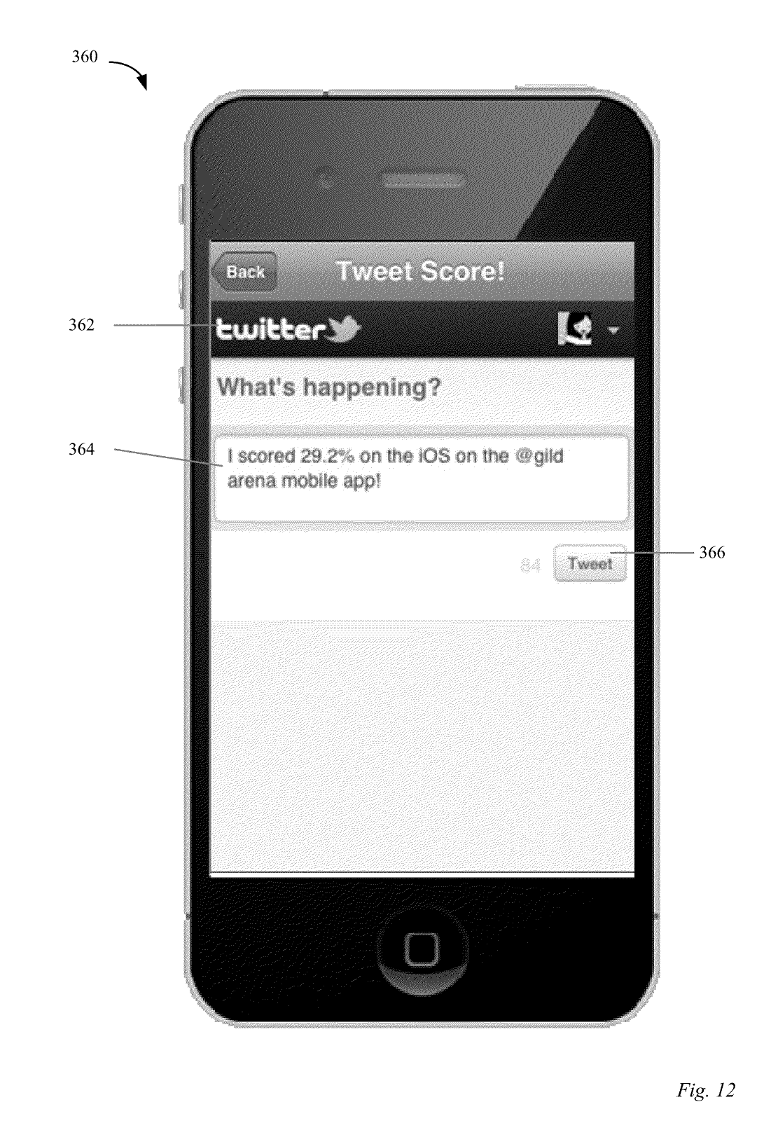

In one embodiment, the interface can be configured to accept social media information. The social media information can be used to allow a participant to post some information associated with their participation in the contest to a social media site, such as but not limited to Facebook™, Google+™, Twitter™ or Linkedin™. In 200, the interface is configured to receive a URL 232 for a twitter post. Further, a format of a twitter message 234 can be specified. In 200, the twitter message includes information about the participants score, a company's name and a job. Further details related to tweeting a score are described below with respect to FIGS. 11 and 12.

Lastly, the interface can be configured to receive a specification of a winner value 90 and its format (Winner Rule 238). In this example, 90% of the questions need to be answered correctly. Another way of specifying the winner could be specifying a number of questions that need to be answered correctly.

In FIG. 4, an interface page 250 for specifying contest components is shown. In this example, a name 252 associated with the contest components is provided. A selectable link 254 allows the user to return to a different page, such as the page illustrated in FIG. 3. In one embodiment, a database of content that can be used in a contest, such as a database including different question can be provided with the system. On page 250, a search feature 256 is provided. The search feature may allow a user to input one or more searchable terms. The searchable terms can be used to locate questions that can be used in the contest.

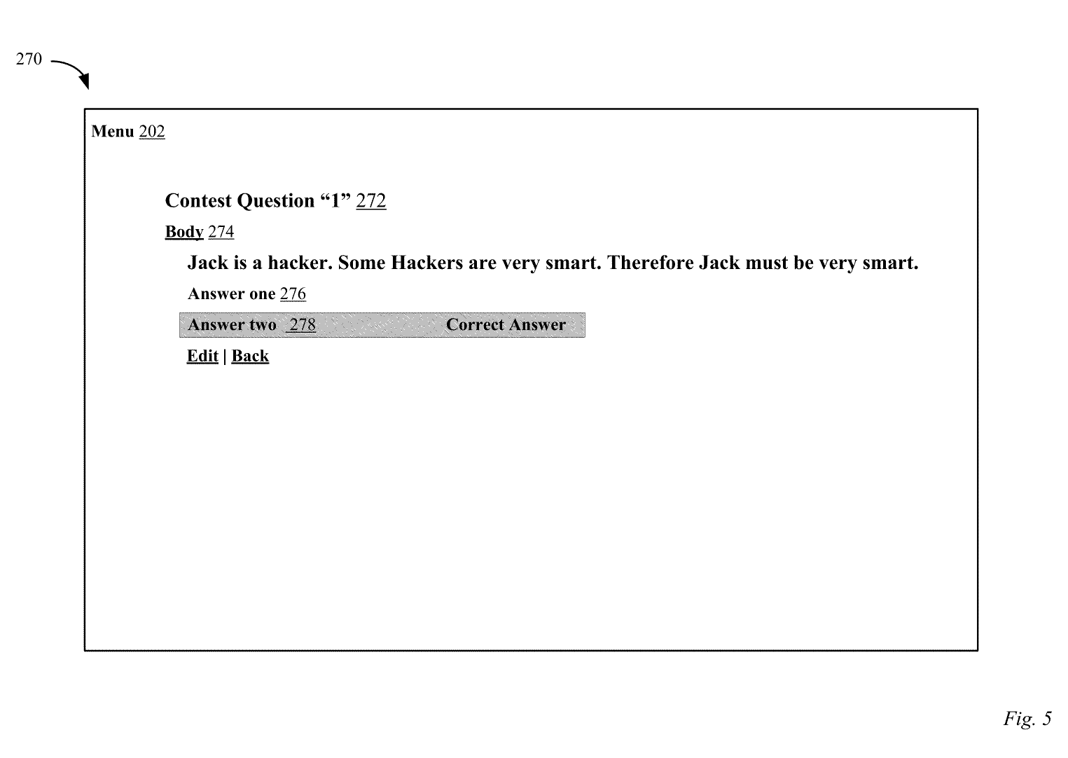

When a question is found via searching or after a user manually inputs a question, the interface can assign an ID 258 to the question. The questions that have been generated are listed according to their ID number. For each question ID number, a question body is specified, such as 262a, 262b and 262c. A number of responses 260 can be tabulated with each question. The number of responses is the number of individuals that have answered the question. This number is updated as the number of participants in the contest increase. Selectable links are provided that allow each question associated with a question ID to be edited or deleted. An example of editing a question is described with respect as follows with respect to FIG. 5.

FIG. 5 shows an interface page where a question with a particular question id 275 can be edited. In this example, the question id number is one. When a question is edited the body of the question 274 is shown. In this example, the body of the question is associated with a logic question, “Jack is a hacker. Some hackers are smart. Therefore Jack must be very smart.” Via the interface, in some instances, the user may be able to edit the body of the question. In other embodiments, the body of the question can be fixed. Thus, the user can delete the question but may not be able to edit the body of the question 240.

In some embodiments, via the interface, a user can specify a plurality of answers to a question. For example, for a true false question, the user can specify answer one 276 as “true” and answer two 278 as “false.” For multiple choice questions, the user may be able to specify a number of different multiple choice answers, such as two, three, four, five, etc. or more multiple choice answers. Where the number of choices can be varied from question to question. The interface may allow a user to specify which answer is the correct answer. In this example, answer two 278 is the correct answer and is shown as highlighted in the interface page 270.

In various embodiments, the interface may allow a user to specify more questions than are presented to a user. For instance, the user can specify fifty questions for a contest where only fifty questions are presented to a participant in the contest. In this embodiment, the system can be configured to select ten questions randomly from the pool of questions each time a contest is instantiated for a particular participant. Thus, the questions administered to each participant can vary from participant to participant. The interface can be configured to allow a number of questions administered and the total number of questions from which the administered questions are selected to be specified.

In other embodiments, each participant can answer the same set of question the questions can be presented in a randomized order such that they vary from person to person. In addition, the order in which the answers appear to the questions can be randomized such that the order of the answers that appear for a particular question vary from participant to participant. In yet another embodiment, a degree of difficulty can be assigned to each question. The degree of difficulty can be used to score the contest such that more difficult questions are given a higher weight in the score.

### Implementation of a Knowledge-Based Contest for Recruiting on a Portable Electronic Device

In this section, an implementation of knowledge-based contest for job recruiting on a portable electronic device, such as smart phone. The knowledge-based contest can be implemented as part of a recruitment enhancement system described above. Other types of electronic devices, such as desktop or tablet computers, can be used to participate in a contest via an associated interface and the example of smart phone is provided for the purposes and is not meant to be limiting. FIGS. 6-13 depict a number of different interface states involving a user participating in a recruitment enhancement activity, such as a knowledge-based contest, implemented on a portable electronic device are described.

In FIG. 6, an image of a front face of a portable electronic device (iPhone™ Apple, Cupertino, Calif.) is shown. A first state of an interface is shown on a display device. In one embodiment, an application may have been downloaded to the device to allow access to the recruitment enhancement activity. In another embodiment, a web-browser can be instantiated on the device and a participant can navigate to a particular web-site via the browser. For example, a participant can scan a QR code or other optically formatted image data that can result in navigation to a particular web-site or a user can manually type in a web-address to arrive at the web-site.

The initial page of an interface that appears in an application or a web-site can indicate a sponsor of the recruitment enhancement activity. In 300, a logo 302 for Gild™ (San Francisco, Calif.) is displayed on the page. In one embodiment, a participant can be required to login via a social media site 304, such as Facebook™ or Linkedin™. A login via one of these sites can allow access to information in the person's social media account, such as their profile on the account. In alternate embodiment, an interface page can be generated that allows a user to sign up for an account and enter basic information, such as a profile. For example, the user can sign-up for an account with Gild™ that allows the user to access various recruitment enhancement activities, such as knowledge-based contests.

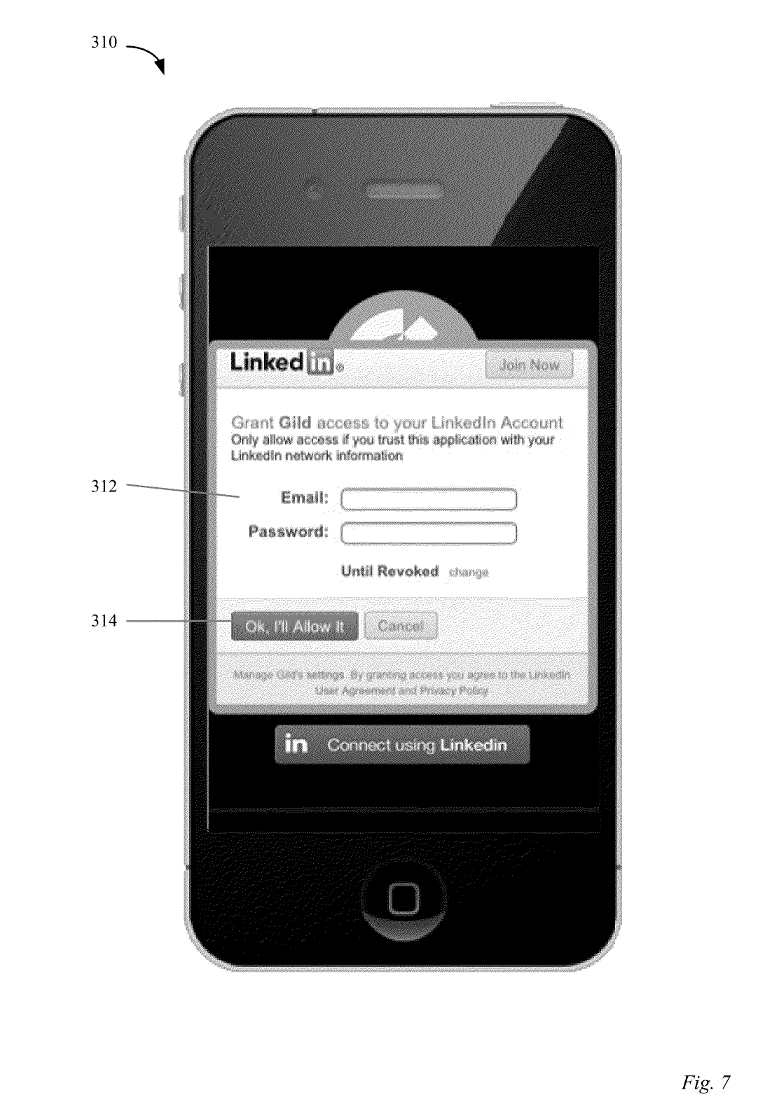

FIG. 7 shows an image 310 of an interface page after a user has selected a social media site. In this example, the user has chosen to login via Linkedin™. In response, the user can be requested to provide information 312 needed to login via the social media site, such as an account identifier (e.g., email address) and a password. A widget can be generated for accepting this information. The user can provide an indication 314 that they grant permission to allow access to their social media account and then select a button to trigger the login. When future logins occur via the same social media site, the user can again login via the social media site but may not be asked for permission to access their data. A user may choose to login at a first time using a first social media site and a second time via a second social media site. The user can be requested to grant access to their information from each site, respectively.

In response to receiving the login information and permission to access account information, such as a profile information, information can be downloaded from the social media site. As described above, the information can be used to indirectly gather information about the individual. The information gathered indirectly can be used to determine one or more job suitability parameters that can be used by a job recruiter to select a candidate for a job position. After a user has granted access to their profile information, the recruitment enhancement system can periodically check for changes in their information. The changes can be used to update job suitability parameters. The checks can occur independently of the user's participation in recruitment enhancement activities, such as knowledge-based contests, used to directly gather information and possibly rank the user.

In one embodiment, as described above, this information can be used to affect a recruitment enhancement activity. For example, if it is learned from a social media account that a user claims to have a particular job related skill, such as a skill appearing on their Linkedin™ profile, a knowledge-based test can be selected for the user related to the skill and the user can be given the option of taking the knowledge-based test. As an example, if a user claims to have experience in a programming language then a knowledge-based test related to the programming language can be selected for the person. As another example, if a user claims to have knowledge of accounting, a knowledge-based test related to account can be selected for the person. One or more tests can be selected for a person in this manner.

In additional embodiments, when it can be determined how much experience the user claims to have in a job related skill, a recruitment enhancement activity, such as a knowledge-based test, can be adjusted to be consistent the claimed level of a job related skill. For example, a different test, such as a test with harder test questions, can be implemented to a person claiming to have five years of experience versus a person claiming to have one year of experience. In addition or alternatively, a test can be scored differently depending on a claimed skill level. For instance, an individual with more experience in a skill can be expected to finish a test faster than an individual with less experience.

As previously described, participants in recruitment enhancement activities, such as knowledge based test can be ranked relative to one another. In one embodiment, participants can be ranked against other participants with a similar level of experience. For example, participants with five to ten years of experience can be grouped together and participants with one to five years of experience can be grouped together for ranking purposes. In another example, a scale on which the participant's performance can be placed can be developed to reflect a specific experience level.

In yet other embodiments, a user can request to participate in a particular recruitment enhancement activity, such as a knowledge based contest. For example, at a job faire or conference, a number of recruitment enhancement activities in which a person may participate, such as knowledge based contests, may be made available. After a user logs into the system, a list of available knowledge-based contests can be presented to the user. The number of contests that are available may relate to skills from many different professions. In one embodiment, the system can be configured to filter recruitment enhancement activities, such as knowledge-based contests, so that only ones of interest to the user are presented. For example, the interface can be configured to receive user preferences in regards to knowledge-based contests or the system can be configured to automatically filter the recruitment enhancement activities based upon information learned from their social media profile.

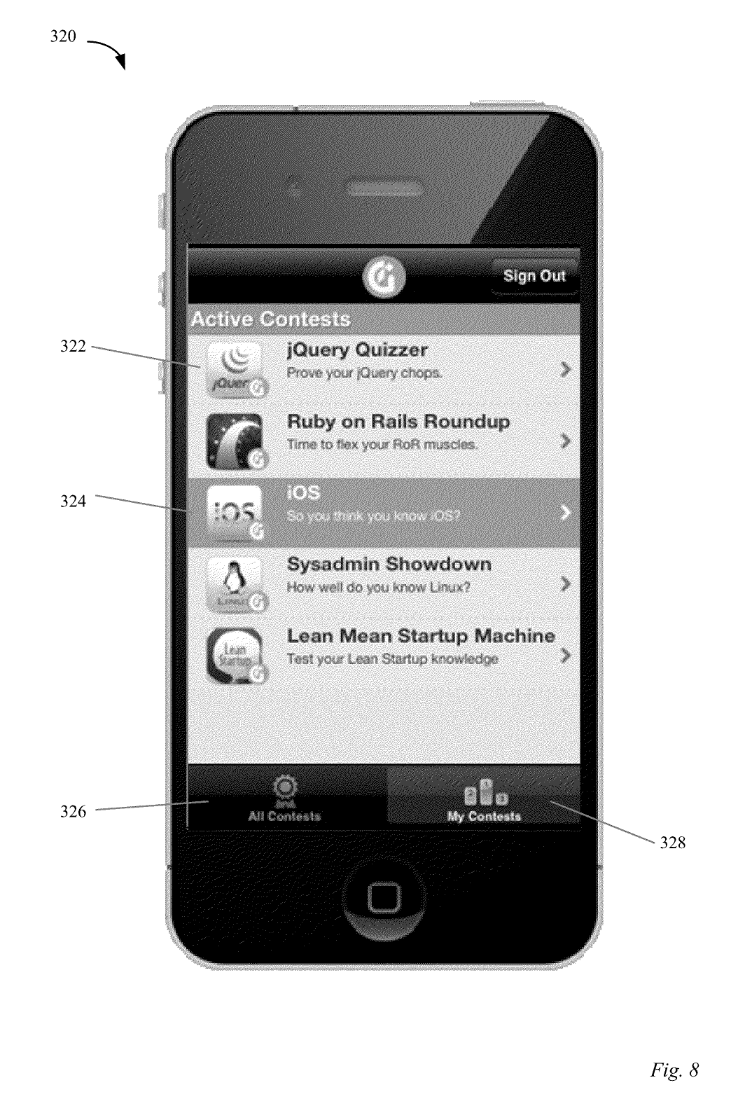

In FIG. 8, a state 320 of an electronic device showing a list 320 of available contests is shown. The list includes knowledge-based contests for jQuery, Ruby on Rails, iOS, system administration or start-up knowledge. In 324, the iOS contest has been selected. In response, the system can initiate the contest. The interface can include a selectable button 326 that allows all contests to be displayed, such as all contests available at a job faire, and a selectable button 328 that causes contests that have been filtered for a user according to their preferences to be displayed and/or causes contests in which a user has participated to appear. For example, the user may select button 328 to view contest in which they have participated to learn their current status on a contest leader board.

In one embodiment, the interface can be configured to indicate sponsors of each knowledge-based contest and possibly job positions associated with each contest. For example, via the interface, the user may be able to learn about companies that have job positions requiring iOS skills. As another example, the user may be able learn about companies that have job positions requiring system administration skills.

In a particular embodiment, a user can gain access to a particular contest only in response to a particular interaction. For example, the user can scan a QR code on a poster at a booth at a job faire to gain access to the contest where the QR code may only be available at the job faire. In another example, an interface, such as a near-field interface, can be provided. The user can pass a place a device, such as a smart phone, in proximity to the near field interface in response the user can gain access to one or more different contests. In yet another example, a local area network may be made available, such as a local Wi-Fi hot spot. Access to one or more different contests may only be granted when a user's device is able to log into the local hot spot.

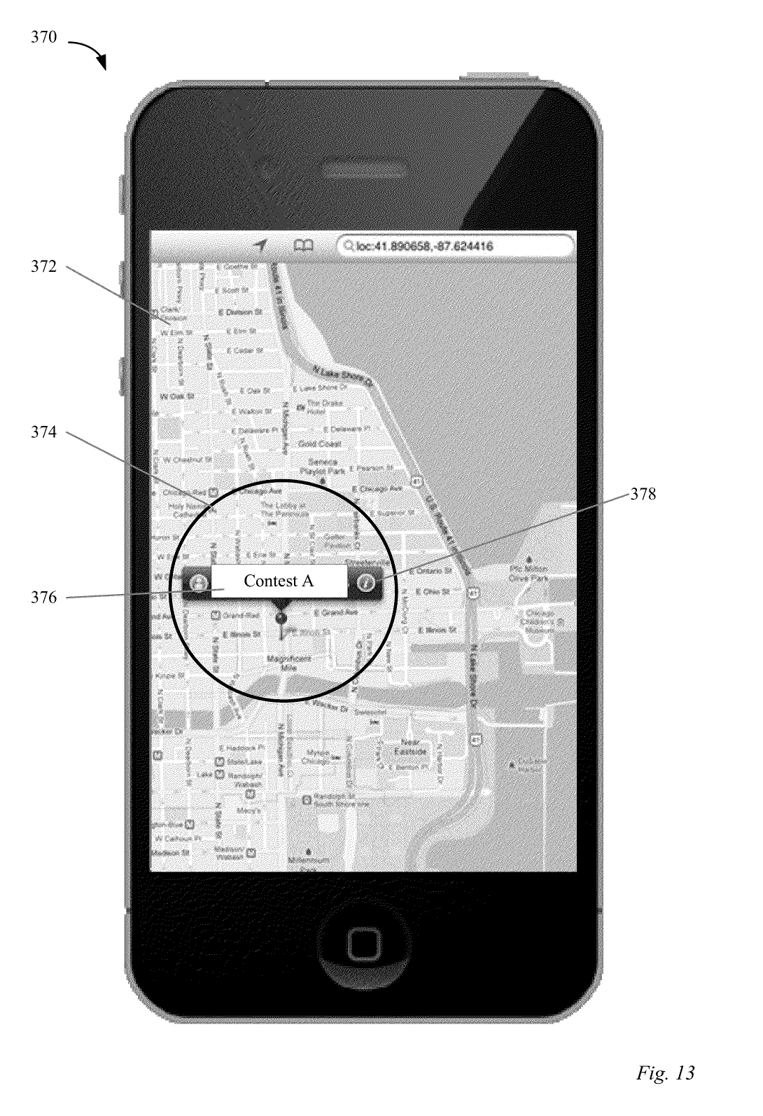

As will be described in more detail with respect to FIG. 13, contest access can be location based. Thus, a person may only be able to participate in a contest when they are within a particular geographic area, such as near a conference site. The user's geographic location can be verified based upon GPS information received from their electronic device or based upon the fact that the user's device has established a connection with a local area network at the geographic location.

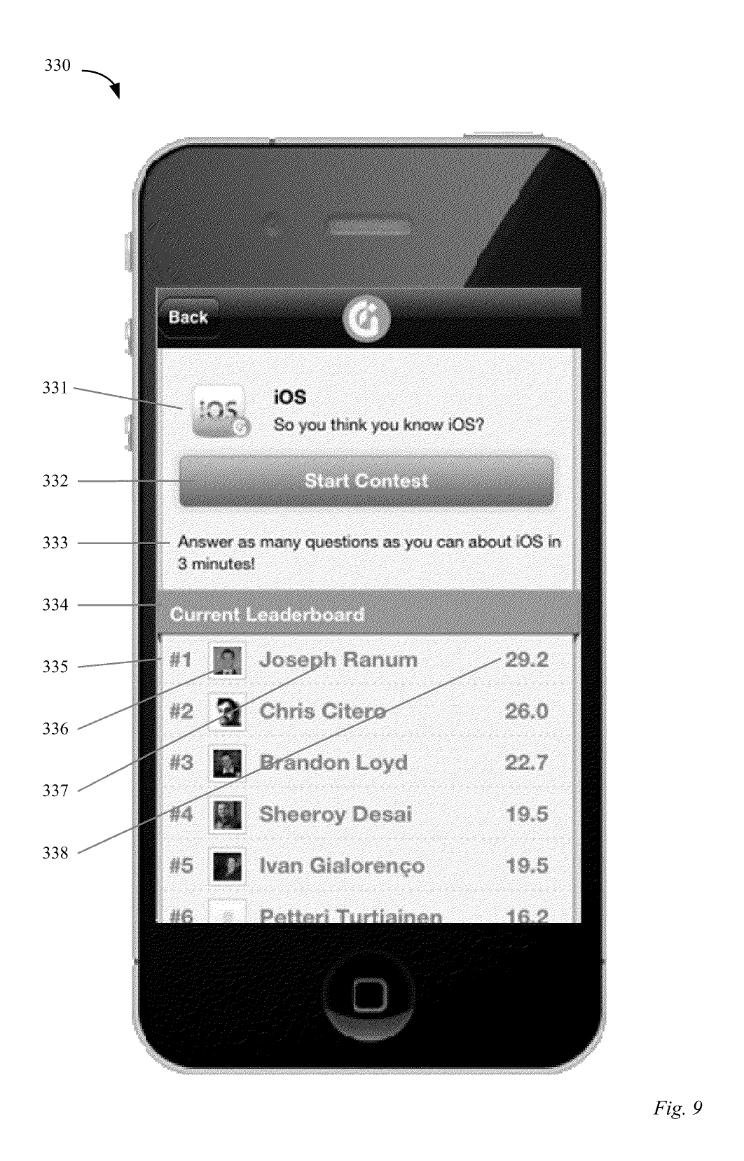

In FIG. 9, a state 330 of the portable electronic device is shown after a user has selected a particular contest in which to participant. A description 321 of the contest is provided. In this example, the contest is related to Apple's iOS™. Rules 333 for the contest are specified. In this example, the rules are to answer as many questions as possible in three minutes. As described above, a prize or prizes for the contest (not shown) can also be listed.

A question database can be generated to account for the fact that different participants can be answer a different amount of questions. In one embodiment, a maximum number of questions that are available can be specified. Thus, if the participant answers all of the questions prior to the three minutes ending, the contest is ended and a score is generated. The score can be adjusted to account for the amount of time it took for the participant to finish the contest. In another embodiment, the question database can be sufficiently large such that a participant can be allowed to answer questions until the contest is completed.

A current leader board 334 can be displayed prior to a user starting a contest. The leader board 334 can include a list of people according to their rank 335. The rank 335 can be determined by their score 338. In one embodiment, the ranks and scores can be presented anonymously. In other embodiments, the ranks and scores can be presented with user identification information, such as information obtained from a profile associated with a social media account.

In 330, an image of each participant 336 and their name 337 shown for the purposes of illustration. In one embodiment, a participant can be given an option of posting their score anonymously or not posting it at all. Further, the user can be given the option of removing a posting of their score after it has been posted. However, even when a score is not posted or removed from posting, the system can keep a record of the participant's score.

When a participant is ready to start the contest, they can select the start contest button 332. In response, the system and/or the application can start generating the activities associated with the contest. For example, if the contest involves playing a game, the game can begin. If the contest involves solving a puzzle, the puzzle can be presented. In this example, the contest includes answering a number of questions and the first question can be presented. As part of a contest, a combination of games, puzzles and questions can be presented.

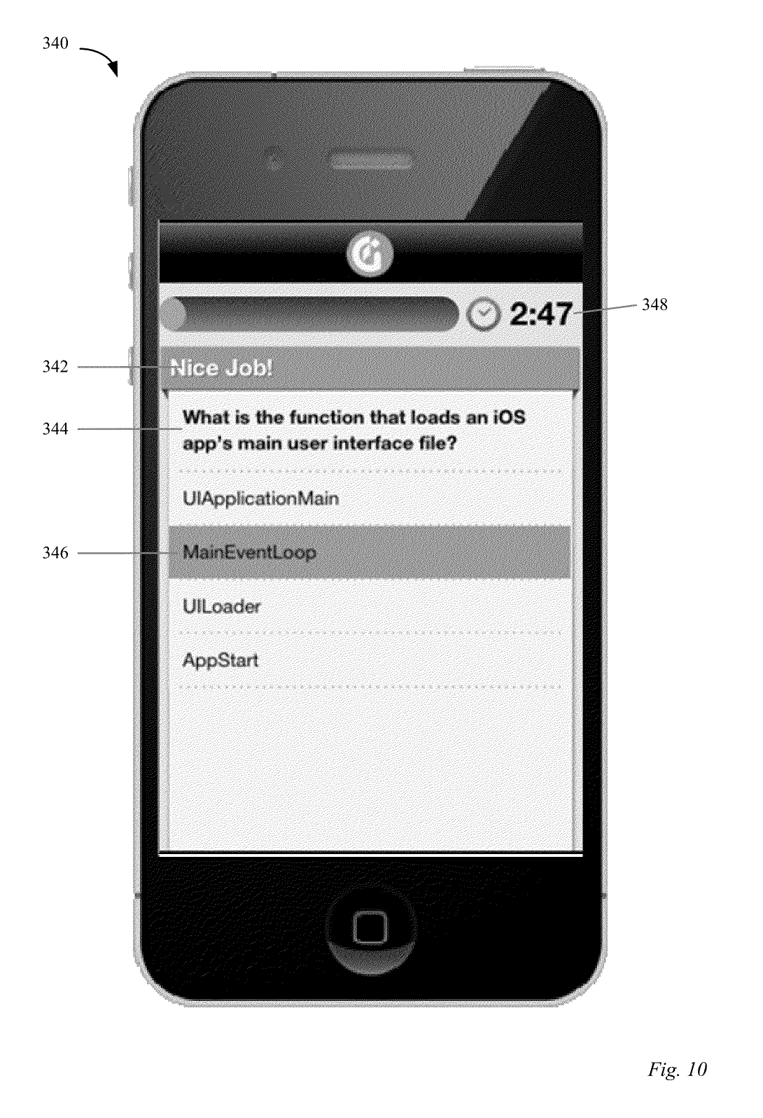

In FIG. 10, a state 340 of the electronic device is shown where a question is output. The time remaining 348 in the contest is presented. A question 344 is displayed and four selectable answers are displayed. In this example, a user has selected one of the answers 346 as their choice which is highlighted. The application or system may or may not indicate whether the answer was correct before moving on to the next question. In this example, the system is configured to indicate whether a response is correct or not. The participant has selected the correct answer and thus, an indication 342 that the answer is correct has been provided.

After it is determined that conditions associated with the contest ending have been met, the contest can end. For example, a time limit may have been reached, all of the questions in the contest may have been or a limit on the number of wrong questions may have been exceeded. In response to the contest ending, the participant's results can be scored 352 and the person can be provided a rank 354 in the contest. As described above, the participant's results can be posted to a leader board. Thus, the leader board can be updated to reflect the participant's results. In this example, the participant's score resulted in their being tied for first place.

In one embodiment, the participant may be allowed only to take the contest one time. After taking the contest, a record of their participation may be maintained. Thus, the person may be to check on the contests in which they have participated and view the current leader board. When the overall contest has ended, winners of the contests can be notified and/or recognized. For example, winners of a prize can be notified.

In one embodiment, the system can be configured to notify a job recruiter based upon the results a contest. For example, if the participant is at a job faire and scores above a certain threshold, a recruiter can be notified. The notification can include contact information for the participant in the contest. The recruiter can then attempt contact the participant, such as for an interview at the job faire. In another example, after the contest has ended, one or more recruiters can receive a list of participants that are ranked above a certain threshold. For example, the recruiters can receive contact information for the participants ranked in the top ten of the contest. After receiving this information, the recruiters can attempt to contact the participants that were ranked in the top ten.

In yet another embodiment, the application can be configured to allow the user to post their score or information about their participation to a social media site, such as Twitter™, Facebook,™ Google+™ or Linkedin™. For example, in 350, a button 356 is provided that allows a user to post tweet their score to twitter. When the button 356 is selected, a tweet can be instantiated.

FIG. 12 is a state 360 of a portable device on which the participant has participated in the contest is shown. The state 360 shows an indication 362 of the social media site that is being utilized. In one embodiment, a message including its content and format can be automatically generated. In this example, the message 364, which reflects the participants score, contest description and the sponsor is “I scored 29.2% on the iOS on the @gild arena mobile application.” As described with respect to FIG. 3, a format of an automated message and its contents can be specified by the administrator for the contest via the administration interface.

If a participant subsequently wins a prize or ranks highly in a contest, an opportunity can be provided for the user to automatically post a message related to a win of the prize or their rank after the contest has ended. For example, the application may be configured to automatically generate a message, such as “I finished first in the iOS contest and won a free iPad at the developer's conference” or “I finished in the top 1% in the iOS contest at the developer's conference.” A selectable button can be provided that allows the participant to automatically post the message to a social media site.

As previously described contests can be geographically limited. In one embodiment, the recruiting application can be configured to generate a map including locations where particular recruiting contests are available. Information on the map can include the location of contests and the contests that are open for the user's participation based on their current location. For example, in FIG. 13, a device state 370 including contest locations is shown. In state 370, a map 372 is shown. A circle 374 is shown around the user's current location is generated on the map. In one embodiment, all contests within the circle 374 may be available to a user. As described above, an account can be maintained for a user that keeps track of all the available contests. In the example, one contest 376 is open to the user. When the button 378 is selected, the user can learn more details about the contest.

In 370, a map is shown of a city. In other embodiments, the map can be of an indoor location. For example, a map of a convention center can be provided. A user might be required to travel to various locations within the convention center floor, such as different booths to access different contests. The map might show the locations of the different contests and/or the user's location. Selectable indicators can be provided on the interface which allow a user to learn additional information about each contest.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

1. A method of electronic job recruiting in a server including a processor and memory, the method comprising:
determining in the processor a recruitment enhancement activity useful for filtering job candidates in a recruiting process is to be generated;
generating in the processor an interface state that allows a participant to grant access to social media information from a social media site;
retrieving in the processor the social media information from the social media site;
generating in the processor a plurality of interface states that allow the participant to participate in the recruitment enhancement activity;
scoring in the processor the participant's participation in the recruitment enhancement activity;
based upon the participant's score, ranking in the processor the participant's performance; and
generating in the processor an interface state that allows a job recruiter to view the participant's score, ranking and the social media information retrieved about the participant from the social media site.

2. The method of claim 1, wherein the recruitment enhancement activity is a knowledge-based test.

3. The method of claim 2, wherein the recruitment enhancement activity is generated in response to the participant applying for a job position and the knowledge-based test is related to a skill associated with the job position.

4. The method of claim 1, wherein the recruitment enhancement activity includes or more of a knowledge-based questions for the participant to answer, a problem for the participant to solve, a game for the participant to play or combinations thereof.

5. The method of claim 1, wherein the recruitment enhancement activity is generated as part of contest.

6. The method of claim 5, further comprising: receiving a description of one or more prizes associated with the contest.

7. The method of claim 5, further comprising: notifying the participant based upon their score and/or ranking that they have won a prize in the contest.

8. The method of claim 5, further comprising: generating a leader board for the contest.

9. The method of claim 5, further comprising: receiving a time period during which the contest is to be implemented.

10. The method of claim 5, further comprising: receiving a location for the contest wherein the participant's eligibility for the contest is based upon the participant's proximity to the location.

11. The method of claim 5, further comprising: receiving a format for a message that can be posted to a social media site after the participant has participated in the contest.

12. The method of claim 1, further comprising: after generating the recruitment enhancement activity is completed, generating an interface state including a pre-formatted message and a selectable button for posting the pre-formatted message to a social media site wherein the pre-formatted message includes information about the recruitment enhancement activity and the participant's performance in the recruitment enhancement activity.

13. The method of claim 12, further comprising, posting the pre-formatted message in response to detecting a selection of the selectable button.

14. The method of claim 1, further comprising: determining whether the participant is eligible to participate in the recruitment enhancement activity.

15. The method of claim 14, wherein the determination of the eligibility is based upon whether the participant has previously participated in the recruitment enhancement activity.

16. The method of claim 14, wherein the determination of the eligibility is based upon whether the participant is located with a particular geographic location.

17. The method of claim 1, further comprising: generating a list of recruitment enhancement activities in which the participant is eligible to participate.

18. The method of claim 1, further comprising: receiving information indicating a claim of a skill that the participant possesses; and
selecting a recruitment enhancement activity for the participant wherein the participant's performance in the recruitment enhancement activity is predictive of whether the participant possesses the claimed skill.

19. The method of claim 18, further comprising: receiving information indicating a skill level for the claimed skill and
based upon the claimed skill level, selecting the recruitment enhancement activity and/or scoring the recruitment enhancement activity.

20. The method of claim 1, wherein the participant is ranked by comparing their performance to a performance a group of other participants that have participated in the recruitment enhancement activity.

21. The method of claim 1, wherein the participant is ranked according to a scale developed for the recruitment enhancement activity.

22. The method of claim 1, further comprising: generating in the processor an interface state that allows a job recruiter to view the participant's score and ranking from a plurality of different recruitment enhancement activities.

23. The method of claim 1, further comprising: receiving a request from a recruiter for the participant to participate in the recruitment enhancement activity and notifying the participant of the recruiter's request to participate in the recruitment enhancement activity.
